(19) United States
(12) Patent Application Publication
(10) Pub. No.: US 2023/0316406 A1
(43) Pub. Date: Oct. 5, 2023

(54) METHODS, SYSTEMS AND COMPUTER PROGRAM PRODUCTS FOR MAKING PAYMENT RECOMMENDATIONS FOR HEALTH CARE CLAIM LINES HAVING DATE SPANS

(71) Applicant: Change Healthcare Holdings LLC, Nashville, TN (US)

(72) Inventors: Tracy Ann WEBER, Longboat Key, FL (US); Daniel LICHVAR, Monroe, CT (US); Rama ATLURI, Swedesboro, NJ (US); Jennifer BEHM, Doylestown, PA (US); Prasanth VIJAYAKUMAR, Stamford, CT (US); Sasidharan KRISHNAKUMAR, Chennai, Tamil Nadu (IN); Khemlall MANGAL, Mascotte, FL (US); Jay PATEL, Bensalem, PA (US); Julissa CANALES, West Haven, CT (US); Elena BUKAREVA, Weston, CT (US)

(21) Appl. No.: 17/708,424

(22) Filed: Mar. 30, 2022

(51) Int. Cl. G06Q 40/08; G06Q 10/10

(52) U.S. Cl. CPC G06Q 40/08; G06Q 10/10

(57) ABSTRACT

A method includes receiving a first claim line identifying a first time span and a first quantity of a health care service provided, and a second claim line identifying a second time span and a second quantity of the health care service provided; determining whether the quantity of health care service provided during the first time span exceeds a maximum amount for a predefined time period; generating a payment recommendation for the first claim line; determining whether a beginning date of the second time span is within the predefined time period and, if so, extending the predefined time period past an ending date of the second time span and generating a payment recommendation for the second claim line in response to determining whether the quantity in the first and second claim lines exceeds a maximum amount for the extended time period.

### FIELD

The present inventive concepts relate generally to health care systems and services and, more particularly, management of claims for health care services processed by payor entities.

### BACKGROUND

Health care services are delivered to patients through health care providers, e.g., one or more medical practitioners. Payment for these services is usually made by one or more payors, which may include the patient and another entity, such as an insurance company. Both private companies and public organizations, such as the Medicare and Medicaid programs run by the federal government, and public employee programs run by the federal government or states, may act as payors. Payors may be penalized for improperly denying payment for health care service claims, but may also be harmed financially for approving payment for claims that cannot be justified. To improve the accuracy in determining which claims to pay, which claims to pay in part, and which claims to deny, payors may use an auditing system that provides recommendations on the payment process. The auditing system may be designed with various packages of rules that can be applied to the claims to make the recommendations on payment.

A health care service claim may include both header and line information. The header may be information that applies to the entire claim, e.g., patient details (name, date of birth, address, etc.). The line information may identify the various services, products, fees, expenses, and/or other items for which payment is sought and may be referred to as line item(s). A payor, such as an insurance company operating in the health care field, may make use of a claims auditing system to assist them in determining whether to pay and how much to pay for the various lines listed in claims submitted for payment.

Unfortunately, conventional auditing systems may not have the ability to accurately review and process claims for services rendered over a period of time (e.g., days, weeks, months, etc.), referred to as a “date span”. Three options are typically available to conventional auditing systems when reviewing and processing claim lines having a date span: 1) ignore the claim line and perform no review; 2) use the beginning date of service in a claim line to process the claim line; or 3) use the ending date of service in a claim line to process the claim line. However, selection of an individual date option can result in incorrect or no auditing of a claim line and may result in a loss of potential editing opportunities as the entire date span is not evaluated accurately.

### SUMMARY

Embodiments of the present inventive concept provide enhanced date span frequency functionality to accurately address claim lines submitted with a date span by evaluating both a line's beginning date of service (referred to as “Line_DosFrom”) and the line's ending date of service (referred to as “Line_DosTo”) and auditing the line accordingly. Date spans may include days, weeks, months, etc. Embodiments of the present inventive concept provide the ability to evaluate claim lines submitted with a date span and to recalculate the maximum frequency allowed for health care services identified in submitted claim lines.

According to some embodiments of the inventive concept, a method comprises receiving a first claim line that identifies a first time span and a first quantity of a health care service provided to a patient during the first time span; determining whether the quantity of the health care service provided to the patient during the first time span exceeds a maximum amount for a predefined time period; determining whether the first time span exceeds the predefined time period; extending the predefined time period past an ending date of the first time span in response to determining whether the first time span exceeds the predefined time period and that the quantity of service provided in the first claim line exceeds the maximum amount for the predefined time period; and generating a payment recommendation for the first claim line in response to determining whether the quantity of the health care service provided to the patient exceeds the maximum amount for the predefined time period and/or in response to determining whether the quantity of the health care service provided in the first time span exceeds a maximum amount for the extended predefined time period. The sender may be a payor and/or provider of the health care service. The predefined time period may be one of the following: one or more days, one or more weeks, one or more months, one or more years. The payment recommendation may be a recommendation to pay or not pay the first claim line.

In some embodiments, the method further comprises receiving a second claim line that identifies a second time span and a second quantity of the health care service provided to the patient during the second time span; determining whether a beginning date of the second time span is within the predefined time period; extending the predefined time period past an ending date of the second time span; generating a payment recommendation for the second claim line in response to determining whether the quantity of the health care service provided to the patient in the first claim line and the quantity of the health care service provided to the patient in the second claim line exceeds a maximum amount for the extended predefined time period, wherein the payment recommendation is a recommendation to pay or not pay the second claim line; and communicating the payment recommendation for the second claim line to a sender of the second claim line.

In some embodiments, the method further comprises generating a third claim line in response to determining that the quantity of the health care service provided in the first claim line and the quantity of the health care service provided in the second claim line exceeds the maximum amount for the extended predefined time period, wherein the third claim line contains a quantity of the health care service provided that is less than the quantity of the health care service provided in the second claim line; generating a recommendation not to pay the second claim line for a quantity of the health care service in the second claim line that exceeds the maximum amount for the predefined time period and a recommendation to pay the third claim line for a quantity of the health care service in the third claim line that does not exceed the maximum amount for the predefined time period; and communicating the payment recommendation for the second claim line and the third claim line to a sender of the first line and the second line.

According to some embodiments of the inventive concept, a system comprises a processor and a memory coupled to the processor and comprising computer readable program code embodied in the memory that is executable by the processor to perform operations comprising: receiving a first claim line that identifies a first time span and a first quantity of a health care service provided to a patient during the first time span; determining whether the quantity of the health care service provided to the patient during the first time span exceeds a maximum amount for a predefined time period; determining whether the first time span exceeds the predefined time period; extending the predefined time period past an ending date of the first time span in response to determining whether the first time span exceeds the predefined time period and that the quantity of service provided in the first claim line exceeds the maximum amount for the predefined time period; and generating a payment recommendation for the first claim line in response to determining whether the quantity of the health care service provided to the patient exceeds the maximum amount for the predefined time period and/or in response to determining whether the quantity of the health care service provided in the first time span exceeds a maximum amount for the extended predefined time period.

In some embodiments, the operations further comprise receiving a second claim line that identifies a second time span and a second quantity of the health care service provided to the patient during the second time span; determining whether a beginning date of the second time span is within the predefined time period; extending the predefined time period past an ending date of the second time span; generating a payment recommendation for the second claim line in response to determining whether the quantity of the health care service provided to the patient in the first claim line and the quantity of the health care service provided to the patient in the second claim line exceeds a maximum amount for the extended predefined time period, wherein the payment recommendation is a recommendation to pay or not pay the second claim line; and communicating the payment recommendation for the second claim line to a sender of the second claim line.

In some embodiments, the operations further comprise generating a third claim line in response to determining that the quantity of the health care service provided in the first claim line and the quantity of the health care service provided in the second claim line exceeds the maximum amount for the extended predefined time period, wherein the third claim line contains a quantity of the health care service provided that is less than the quantity of the health care service provided in the second claim line; generating a recommendation not to pay the second claim line for a quantity of the health care service in the second claim line that exceeds the maximum amount for the predefined time period and a recommendation to pay the third claim line for a quantity of the health care service in the third claim line that does not exceed the maximum amount for the predefined time period; and communicating the payment recommendation for the second claim line and the third claim line to the sender.

According to some embodiments of the inventive concept, a computer program product, comprises a non-transitory computer readable storage medium comprising computer readable program code embodied in the medium that is executable by a processor to perform operations comprising receiving a first claim line that identifies a first time span and a first quantity of a health care service provided to a patient during the first time span; determining whether the quantity of the health care service provided to the patient during the first time span exceeds a maximum amount for a predefined time period; determining whether the first time span exceeds the predefined time period; extending the predefined time period past an ending date of the first time span in response to determining whether the first time span exceeds the predefined time period and that the quantity of service provided in the first claim line exceeds the maximum amount for the predefined time period; and generating a payment recommendation for the first claim line in response to determining whether the quantity of the health care service provided to the patient exceeds the maximum amount for the predefined time period and/or in response to determining whether the quantity of the health care service provided in the first time span exceeds a maximum amount for the extended predefined time period.

In some embodiments, the operations further comprise receiving a second claim line that identifies a second time span and a second quantity of the health care service provided to the patient during the second time span; determining whether a beginning date of the second time span is within the predefined time period; extending the predefined time period past an ending date of the second time span; generating a payment recommendation for the second claim line in response to determining whether the quantity of the health care service provided to the patient in the first claim line and the quantity of the health care service provided to the patient in the second claim line exceeds a maximum amount for the extended predefined time period, wherein the payment recommendation is a recommendation to pay or not pay the second claim line; and communicating the payment recommendation for the second claim line to a sender of the second claim line.

In some embodiments, the operations further comprise generating a third claim line in response to determining that the quantity of the health care service provided in the first claim line and the quantity of the health care service provided in the second claim line exceeds the maximum amount for the extended predefined time period, wherein the third claim line contains a quantity of the health care service provided that is less than the quantity of the health care service provided in the second claim line; generating a recommendation not to pay the second claim line and a recommendation to pay the third claim line; and communicating the payment recommendation for the second claim line and the third claim line to the sender.

It is noted that aspects described with respect to one embodiment may be incorporated in different embodiments although not specifically described relative thereto. That is, all embodiments and/or features of any embodiments can be combined in any way and/or combination. Moreover, other methods, systems, articles of manufacture, and/or computer program products according to embodiments of the inventive concept will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims. It is further intended that all embodiments disclosed herein can be implemented separately or combined in any way and/or combination.

### BRIEF DESCRIPTION OF THE DRAWINGS

The accompanying drawings, which form a part of the specification, illustrate various embodiments of the present invention. The drawings and description together serve to fully explain embodiments of the present invention.

FIGS. 1 and 2 are block diagrams of an auditing system for health care service claims in accordance with some embodiments of the inventive concept.

FIGS. 3-5 are flowcharts that illustrate operations for generating processing recommendations for health care service claims having date spans using the auditing system of FIGS. 1 and 2 in accordance with some embodiments of the inventive concept.

FIGS. 6-8, 9A, 9B, 10A and 10B illustrate examples of processing health care service claims having date spans in accordance with some embodiments of the inventive concept.

FIG. 11 is a block diagram that illustrates a data processing system that may be used to implement one or more servers in the auditing system of FIGS. 1 and 2 in accordance with some embodiments of the inventive concept.

FIG. 12 is a block diagram that illustrates a software/hardware architecture for use in the auditing system of FIGS. 1 and 2 in accordance with some embodiments of the inventive concept.

### DETAILED DESCRIPTION

In the following detailed description, numerous specific details are set forth to provide a thorough understanding of embodiments of the present inventive concept. However, it will be understood by those skilled in the art that the present invention may be practiced without these specific details. In some instances, well-known methods, procedures, components and circuits have not been described in detail so as not to obscure the present inventive concept. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

As used herein, the term “health care service” is intended to include all medical services and products (e.g., medications, medical devices, etc.) provided to a patient.

As used herein, the term “provider” may mean any person or entity involved in providing a health care service to a patient.

As used herein, the terms “claim” and “claim line” are interchangeable and refer to a request for payment for services and products provided to a patient, as well as for administrative fees and/or other fees and expenses incurred in providing medical care to a patient.

As used herein, the term “policy window” is a predefined time period for which a maximum quantity of a particular health care service is defined for a particular policy. The predefined time period may be one or more days, one or more weeks, one or more months, one or more years, etc.

As used herein, the terms “date span” and “time span” are interchangeable and refer to a period of time including one or more days, one or more weeks, one or more months, one or more years, etc.

Some embodiments of the inventive concept are described with reference to a payor determining whether to make payment for a claim for health care services. A payor may be, for example, an entity that provides health or medical insurance, such as private insurance companies and government insurance agencies, both at the federal and state levels (e.g., Medicare, Medicaid, public employee insurance agencies, and the like). Health care providers may submit claims for medical services rendered, products prescribed (e.g., medications, medical devices, etc.), administrative fees, and/or other fees or expenses to a payor for payment. Upon receiving a claim, the payor may then determine whether to pay the claim in whole, in part, or deny the claim. As described above, payors may be penalized for improperly denying payment of a claim. But a payor may suffer economically if payment is made for fraudulent claims or claims for which reimbursement has not been authorized or contracted for. Some embodiments of the inventive concept stem from a realization that the claims auditing system used by a payor may not be able to accurately process claim lines for medical care rendered over a period of time (i.e., having a date span).

The rules applied to claim line items via the inventive concept may result in the denial of payment or a reduction in payment amount for one or more line items that otherwise would have been approved by an auditing system without the ability to process claim lines with date spans, thereby providing savings to the payor.

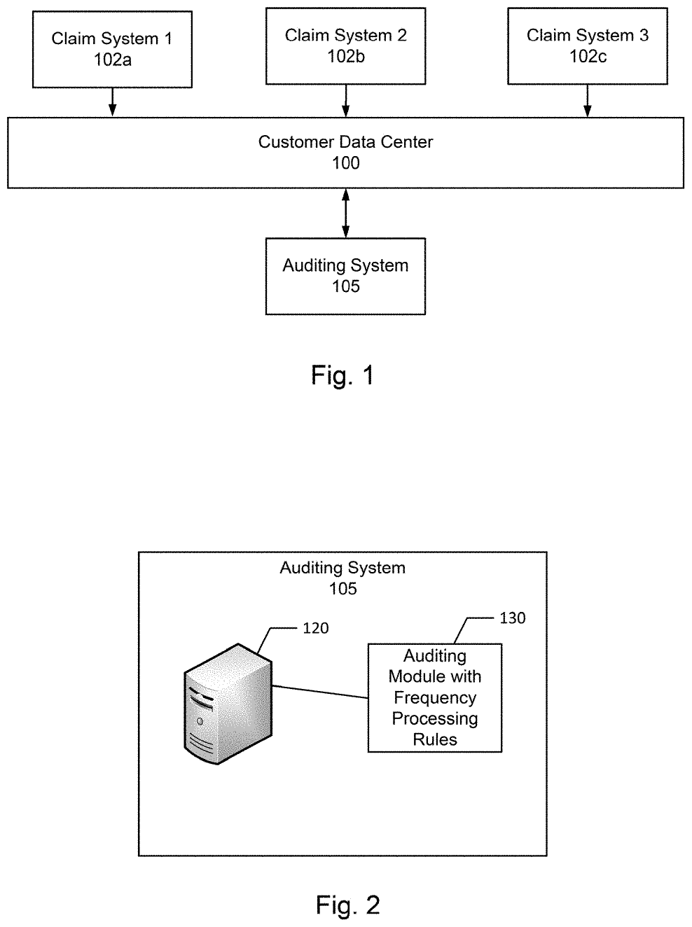

FIG. 1 is a block diagram of an auditing system for health care service claims in accordance with some embodiments of the inventive concept. A payor, such as an insurance entity operating in the health care field, may have a customer data center 100 through which claims are evaluated and processed for payment. The claims may be received through one or more claims systems, such as claim system 1 102a, claim system 2 102b, and claim system 3 102c. Each of these claim systems 102a, 102b, and 102c may be used to receive and coordinate payment for claims generated by providers (e.g., health care or medical service providers). The claim systems 102a, 102b, and 102c may use different formats, but the claims may each include header information and line information or line items as described above. The payor may use the customer data center 100 to organize the claims and evaluate whether to pay the claims in whole, in part, or to deny the claims. The customer data center 100 may be representative of any entity for handling or processing claims. In the example embodiments provided herein, the claims systems 102a, 102b, and 102c may be integrated into the auditing system 105, and the customer data center 100 may provide a user interface. Each claim system may be independent of the other and have its own auditing system as well as its own user interface. The payor may use an auditing system 105, which contains rules for evaluating the claims for payment (in whole or part) or non-payment (claim denial or rejection).

Referring to FIG. 2, the auditing system 105 may be implemented by one or more servers 120 that are configured to evaluate whether to pay, pay in part, or deny payment for line items in claims that are processed for payment in the customer data center 100. The auditing system server(s) 120 includes an auditing module 130 having rules for evaluating and making payment recommendations for the line items in the claims, including rules for claim lines containing date spans. The auditing module 130 may also include history information on past claims received and processed, which can be used in evaluating new claims for payment. For example, if a patient is limited to a certain number of physical therapy sessions, then historical claims may be consulted to determine if a patient has reached a limit for which payment is authorized. The customer data center 100 may be configured with a user interface that allows a customer, e.g., a payor, to view the recommendations generated by the auditing system server(s) 120 for claims and the individual line items contained therein. In some embodiments, the user interface may allow a payor to review which specific rules have been triggered in the auditing system server(s) 120 in making a recommendation. It will be understood that the functionality and capabilities of the auditing module 130 may be logically combined/divided among one or more physical servers 120.

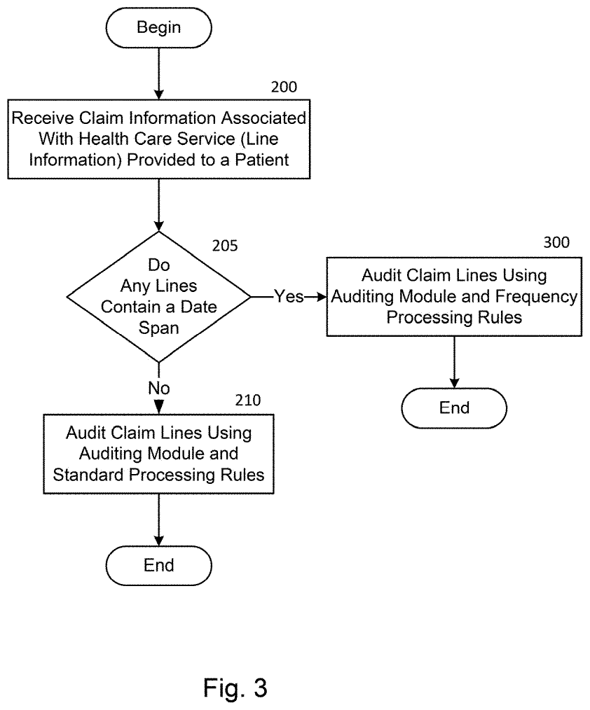

FIGS. 3-5 are flowcharts that illustrate operations for generating processing recommendations, e.g., payment recommendations, for health care service claims using an auditing system in accordance with some embodiments of the inventive concept. Referring now to FIG. 3, information associated with a health care service, e.g., claim information including header information and line item information, is received at a customer data center 100 and provided, for example, to an auditing system sever 120 at block 200. The auditing system server 120 makes a determination whether the claim information received contains one or more date spans at block 205. If no date spans are present in any of the line items in the claim information, at block 210 the claim information is audited using the auditing system 105 with standard processing rules to generate a payment recommendation. However, if date spans are present, at block 300 the claim information is audited using the auditing module 130 with frequency processing rules according to embodiments of the inventive concept to generate a payment recommendation.

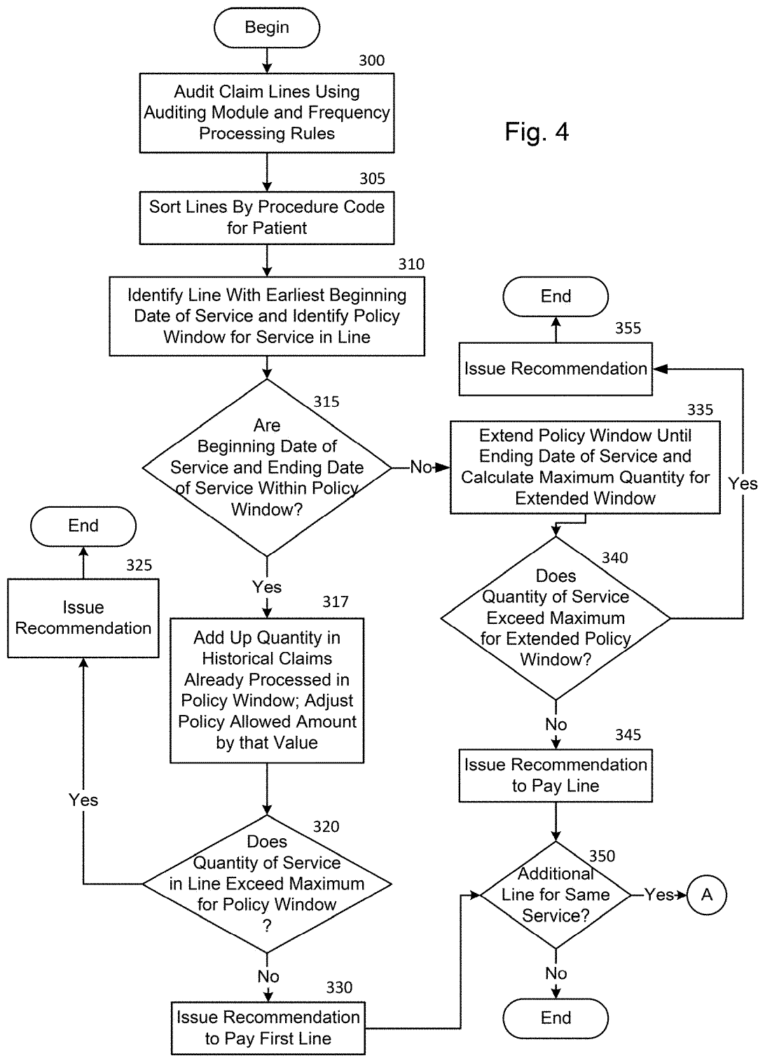

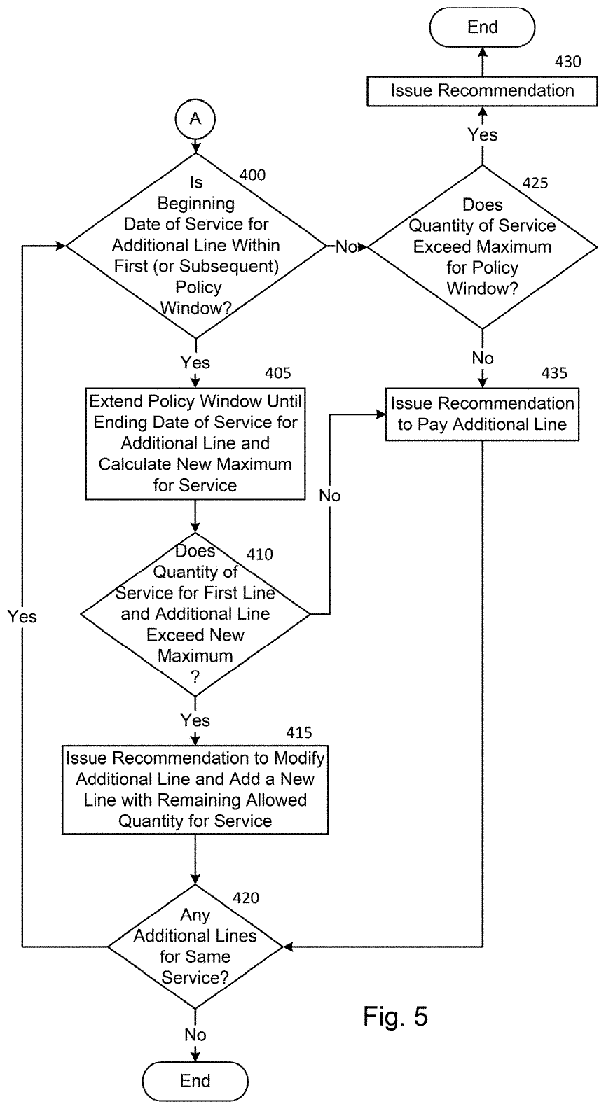

Referring to FIG. 4, claim lines containing date spans may be initially sorted by procedure code for a patient at block 305. A procedure code is a unique code assigned to a particular health care service provided to a patient. The set of claim lines with the same procedure code for a patient may then be placed in order by the beginning date of service (Line_DosFrom). A line in the set of claim lines having the earliest beginning date of service (Line_DosFrom) of all of the lines is identified and a policy window for the particular procedure code is identified at block 310. A policy window is defined by the rules/polices of the particular payor requesting the review of the claims, and may be any time period, such as one or more days, one or more weeks, one or more months, one or more years. In addition, the maximum quantity of service authorized for a particular policy window is defined by the rules/policies of the payor. At block 315, a determination is made whether the beginning date of service in the line (Line_DosFrom) and the ending date of service in the line (Line_DosTo) are within the policy window for the procedure code. If the answer is yes, the quantities from any historical claims that meet the policy window criteria are added up, if any, and the policy window's allowed quantity is adjusted by the historical quantity at block 317. Then, at block 320 a determination is made whether the quantity of service in the line exceeds a maximum for the policy window. If the answer is yes, a recommendation is issued at block 325. This recommendation may be to allow some of the claim and deny some of the claim. If the answer is no, a recommendation to pay the claim line is issued at block 330 and then a determination is made at block 350 if additional claim lines for the same procedure code exist. If the answer at block 350 is no, operations end for this claim. However, if the answer at block 350 is yes, operations for auditing an additional line(s) begin at block 400 (FIG. 5), and will be described further below.

Referring back to block 315, if for the initial claim line the beginning date of service in the line (Line_DosFrom) and the ending date of service in the line (Line_DosTo) are not within the policy window for the procedure code, the policy window is extended (also referred to as “sliding the window”) to include the ending date of service in the line (Line_DosTo) and a maximum quantity for the extended policy window is calculated at block 335. In some situations, the policy window may need to be extended multiple times at block 335, in which case the maximum quantity for the extended policy window is equal to the maximum quantity for the initial window (as defined by the rules/policies of the payor) multiplied by the number of times the initial policy window is extended. At block 340, a determination is made whether the quantity of service in the line exceeds the maximum for the extended policy window. If the answer is no, a recommendation to pay the claim line is issued at block 345 and then a determination is made at block 350 if additional claim lines for the same procedure code exist. If the answer at block 340 is yes (i.e., the quantity of service in the line exceeds the maximum for the extended time window), a recommendation is issued at block 355. This recommendation may be to allow some of the claim (e.g., the amount equal to the maximum quantity for the extended time window), and deny some of the claim (e.g., the amount in excess of the maximum quantity for the extended time window).

Referring to FIG. 5, at block 400 a determination is made for an additional claim line whether the beginning date of service in the additional line (Line_DosFrom) is within the first policy window (or a subsequent policy window, if multiple claim lines), for the procedure code. If the answer is yes, the policy window is extended to include the ending date of service (Line_DosTo) for the additional line and a new maximum quantity for the service is calculated at block 405, as defined by the rules/polices of the payor. At block 410 a determination is made whether the quantity of service for the first line and the additional line exceed the new maximum. If the answer is yes, a recommendation to modify the additional claim line is issued at block 415 and a new line is created that contains the remaining allowed quantity for the service. In particular, a recommendation to deny the additional claim is issued and a new claim line that includes only the amount still available for the extended time window (i.e., the maximum quantity for the extended time window less the service quantity associated with any preceding claim lines) is generated, with a recommendation to pay. A determination is made at block 420 if any additional claim lines for the same procedure code exist. If the answer at block 420 is yes, operations return to block 400. Operations continue as described above for as many lines that exist. If the answer is no, operations are ended.

Returning to block 410, if the quantity of service for the first line and the additional line do not exceed the new maximum, a recommendation to pay the additional line is issued at block 435. A determination is made at block 420 if additional claim lines for the same procedure code exist. If the answer at block 420 is yes, operations return to block 400. Operations continue as described above for as many lines that exist. If the answer is no, operations are ended.

Returning to block 400, if the beginning date of service in the additional line (Line_DosFrom) is not within the initial (or subsequent) policy window for the procedure code (i.e., the claim line is in a new/different policy window than the previous claim lines), a determination is made whether the quantity of service in the additional line exceeds the maximum for the policy window at block 425. If the answer is yes, a recommendation is issued at block 430. This recommendation may be to allow some of the claim and deny some of the claim. If the answer at block 425 is no, a recommendation to pay the additional claim line is issued at block 435 and then a determination is made at block 420 if additional claim lines for the same service exist. If the answer is yes, operations continue at block 400, as described above.

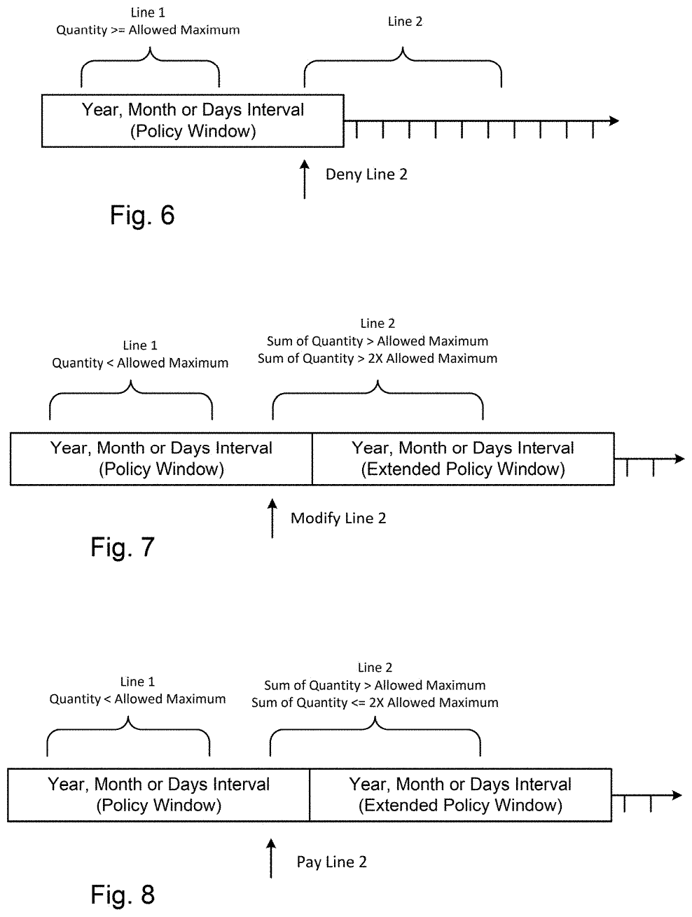

FIGS. 6-8, 9A, 9B, 10A and 10B illustrate examples of processing health care service claims having date spans in accordance with some embodiments of the inventive concept. Referring to FIG. 6, an example of the logic utilized by the auditing module 130 will now be described. FIG. 6 illustrates two claim lines (Line 1 and Line 2) and a policy window for the procedure code associated with the claim lines. Each of the claim lines has a date span, i.e., a beginning date of service (Line_DosFrom) and an ending date of service (Line_DosTo). The date span of Line 1 is within the policy window (block 315, FIG. 4) and the quantity of service identified in Line 1 is greater or equal to the maximum allowed for the policy window. As such, a recommendation is made to approve only the maximum quantity of service in Line 1 for the policy window (block 325, FIG. 4). Line 2 has a beginning date of service (Line_DosFrom) that is within the policy window. Because the quantity of service in Line 1 is equal to or greater than what is allowed for the policy window, a recommendation is made to deny Line 2 (block 325, FIG. 4) and the window is not extended into the second date span.

FIG. 7 illustrates two claim lines (Line 1 and Line 2). The beginning date of service (Line_DosFrom) and the ending date of service (Line_DosTo) for Line 1 are both within the policy window (block 315, FIG. 4), and the quantity of service in Line 1 is less than the maximum quantity allowed with the policy window (block 320, FIG. 4). The beginning date of service (Line_DosFrom) for Line 2 is within the first policy window and the ending date of service (Line_DosTo) is outside of the first policy window. However, since the quantity of service in Line 1 did not exceed the maximum allowed in the first policy window, a recommendation to pay Line 1 is issued (block 330, FIG. 4) and the policy window is extended to add a second policy window (block 405, FIG. 5). Because there are now two policy windows, the maximum quantity of service allowed in the combined windows is doubled. The total quantity of service for Line 1 and Line 2 is greater than both the maximum allowed for the policy window and the maximum quantity for the two policy windows (i.e., the extended policy window). As such, a recommendation is made to modify Line 2 by denying Line 2 and adding a new Line 3 that includes the remaining available quantity of service with Line 1 as support (block 415, FIG. 5).

FIG. 8 illustrates two claim lines (Line 1 and Line 2). The beginning date of service (Line_DosFrom) and the ending date of service (Line_DosTo) for Line 1 are both within the policy window (block 315, FIG. 4), and the quantity of service in Line 1 is less than the maximum quantity allowed with the policy window. Thus, a recommendation is made to pay Line 1 (block 330, FIG. 4). The beginning date of service (Line_DosFrom) for Line 2 is within the first policy window and the ending date of service (Line_DosTo) is outside of the first policy window (block 400, FIG. 5). However, since the quantity of service in Line 1 did not exceed the maximum allowed in the first policy window, the policy window is extended to add a second policy window (block 405, FIG. 5). Because there are now two policy windows, the maximum quantity of service allowed in the combined windows is doubled. The quantity of service in Line 2 is greater than the maximum allowed for the initial policy window. However, the total quantity of service for Line 1 and Line 2 is less than or equal to the maximum quantity for the two policy windows (block 410, FIG. 5). As such, a recommendation is made to pay Line 2 (block 435, FIG. 5).

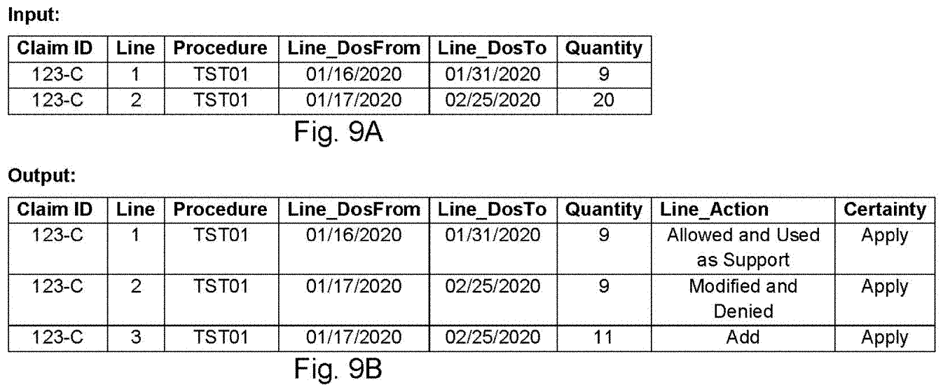

Referring to FIGS. 9A-9B, another example of claim line review according to embodiments of the inventive concept is illustrated. In FIG. 9A, the auditing module 130 receives two claim lines, Line 1 and Line 2, as input, each having the same procedure code (TST01). Line 1 has a beginning date of service (Line_DosFrom) of Jan. 16, 2020, an ending date of service (Line_DosTo) of Jan. 31, 2020, and a quantity of service of 9. Line 2 has a beginning date of service (Line_DosFrom) of Jan. 17, 2020, an ending date of service (Line_DosTo) of Feb. 25, 2020, and a quantity of service of 20. For the particular procedure code, a maximum quantity of service allowed is ten (10) in a calendar month (i.e., the policy window). Line 1 represents a date span that falls within January 2020 (i.e., the policy window) and is processed first since it has the earliest beginning date of service (block 310, FIG. 4). Since the quantity 9 is less than the maximum of 10 allowed, a recommendation is made to pay Line 1 (block 330, FIG. 4). Processing then moves to Line 2 (block 350, FIG. 4). Line 2 represents a date span that falls within January and February 2020 (i.e., two policy windows). Thus, the policy window of one month is extended to two months since the maximum allowed quantity was not met on Line 1 (block 405, FIG. 5). The new maximum allowed is calculated for the January/February window as 10×2=20. The quantity for Line 1 (9) and the additional Line 2 (20) exceeds the new maximum quantity (20). Therefore, Line 2 is modified (block 415, FIG. 5), using Line 1 as support, to split Line 2 into two lines, where Line 2 is denied and the quantity reflects the remainder of 20 (original)−11 (1 allowed in January and 10 allowed in February)=9. A new line, Line 3, is added with the remaining allowed quantity of 11 (i.e., the maximum quantity for the extended time window (20) less the quantity of service for Line 1 (9)). The output of processing is represented by FIG. 9B, (i.e., Line 1 is supported (allowed), Line 2 is modified and denied, and new Line 3 is added).

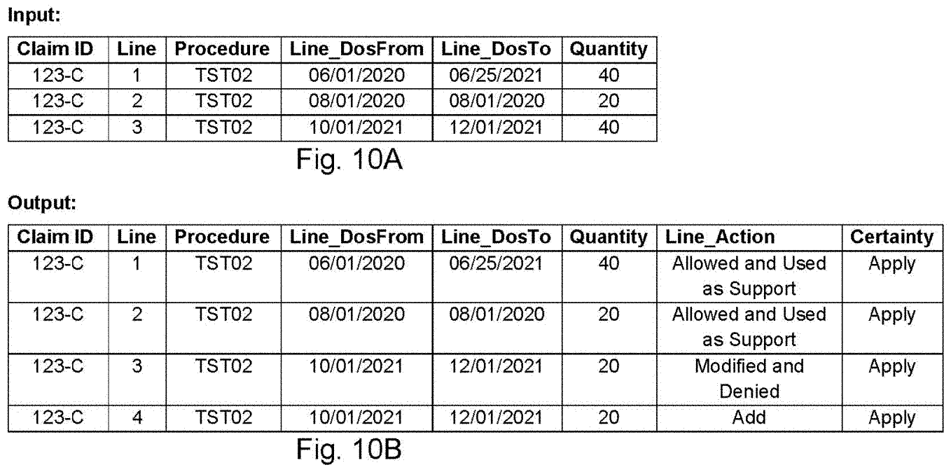

Referring to FIGS. 10A-10B, another example of claim line review according to embodiments of the inventive concept is illustrated. In FIG. 10A, the auditing module 130 receives three claim lines, Line 1, Line 2 and Line 3 as input, each line having the same procedure code (TST02). Line 1 has a beginning date of service (Line_DosFrom) of Jun. 1, 2020, an ending date of service (Line_DosTo) of Jun. 25, 2021, and a quantity of service of 40. Line 2 has a beginning date of service (Line_DosFrom) of Aug. 1, 2020, an ending date of service (Line_DosTo) of Aug. 1, 2020, and a quantity of service of 20. Line 3 has a beginning date of service (Line_DosFrom) of Oct. 1, 2021, an ending date of service (Line_DosTo) of Dec. 1, 2021, and a quantity of service of 40. For the particular procedure code, a maximum quantity of service allowed is forty (40) in a calendar year (i.e., the policy window). Line 1 represents a date span that falls between two calendar years 2020 and 2021 (i.e., between two policy windows). Line 2 falls entirely within 2020 (i.e., within one policy window), and Line 3 falls entirely within 2021 (i.e., within one policy window). Line 1 is processed first since it has the earliest beginning date of service (block 310, FIG. 4). Since the beginning and ending dates of service are not within a single policy window (block 315, FIG. 4), the policy window is extended and a maximum quantity for the extended window is calculated (block 335, FIG. 4). Since the quantity 40 is not greater than the maximum for two calendar years (i.e., the extended time window), a recommendation is made to pay Line 1 (block 345, FIG. 4). Processing then moves to Line 2 (block 350, FIG. 4). Line 2 represents a date span that falls entirely within 2020, but after the calendar year span of Line 1, and the quantity is less than the maximum for a calendar year. Line 3 represents a date span after the date span of Line 2. As such, the policy window is extended for two years since the maximum allowed quantity for Lines 2 and 3 was not met for a calendar year. The new maximum allowed is calculated for the 2020/2021 window as 40×2=80. A recommendation is made to pay Line 2 (block 410, FIG. 5), Line 3 is modified (block 415, FIG. 5), and a new line, Line 4 is added with the remaining quantity 20 (block 415, FIG. 5). The output of processing is represented by FIG. 10B, (i.e., Line 1 is supported (allowed), Line 2 is supported (allowed), Line 3 is modified and denied, and new Line 4 is added).

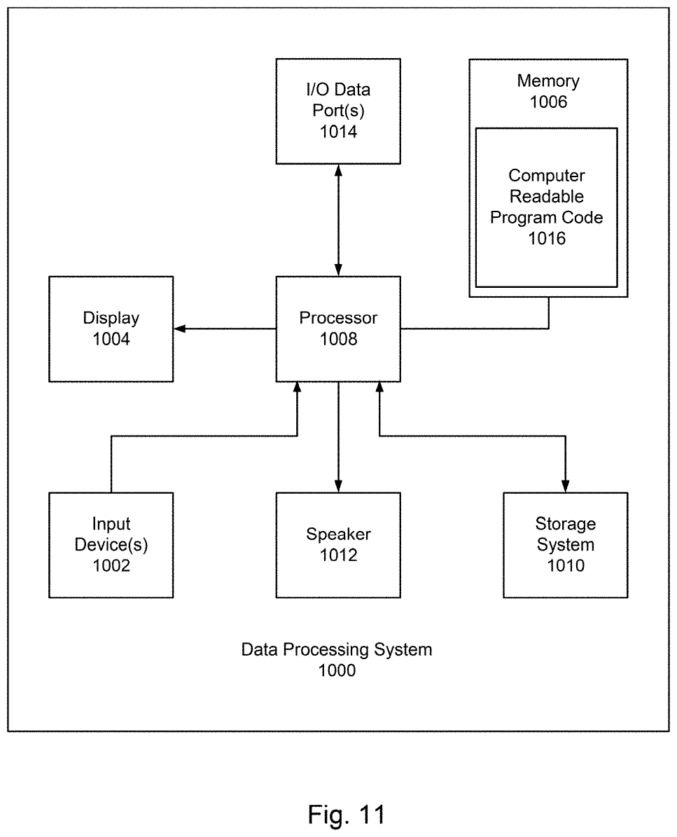

Referring now to FIG. 11, a data processing system 1000 that may be used to implement the auditing system server 120 and frequency processing auditing module 130 of FIG. 2, in accordance with some embodiments of the inventive concept, comprises input device(s) 1002, such as a keyboard or keypad, a display 1004, and a memory 1006 that communicate with a processor 1008. The data processing system 1000 may further include a storage system 1010, a speaker 1012, and an input/output (I/O) data port(s) 1014 that also communicate with the processor 1008. The processor 1008 may be, for example, a commercially available or custom microprocessor. The storage system 1010 may include removable and/or fixed media, such as floppy disks, ZIP drives, hard disks, or the like, as well as virtual storage, such as a RAMDISK. The I/O data port(s) 1014 may be used to transfer information between the data processing system 1000 and another computer system or a network (e.g., the Internet). These components may be conventional components, such as those used in many conventional computing devices, and their functionality, with respect to conventional operations, is generally known to those skilled in the art. The memory 1006 may be configured with computer readable program code 1016 to facilitate generating processing recommendations for health care service claims using an auditing system according to some embodiments of the inventive concept.

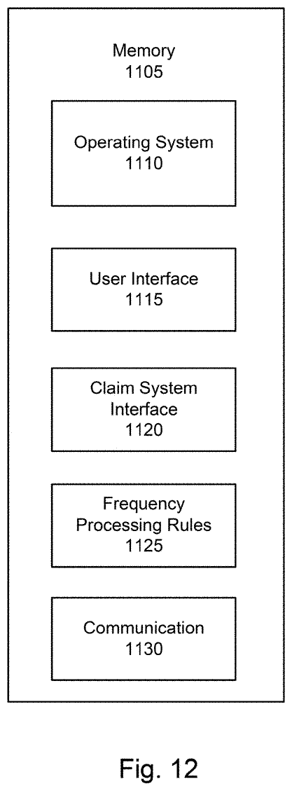

FIG. 12 illustrates a memory 1105 that may be used in embodiments of data processing systems, such as the auditing system server 120 and frequency processing auditing module 130 of FIG. 2 and the data processing system 1000 of FIG. 11, respectively, to facilitate generating processing recommendations for health care service claims using an auditing system according to some embodiments of the inventive concept. The memory 1105 is representative of the one or more memory devices containing the software and data used for facilitating operations of the auditing system server(s) 120 described herein. The memory 1105 may include, but is not limited to, the following types of devices: cache, ROM, PROM, EPROM, EEPROM, flash, SRAM, and DRAM. As shown in FIG. 12, the memory 1105 may contain five or more categories of software and/or data: an operating system 1110, a user interface module 1115, a claim system interface module 1120, and a rules module 1125, and a communication module 1130. In particular, the operating system 1110 may manage the data processing system's software and/or hardware resources and may coordinate execution of programs by the processor. The user interface module 1115 may be configured to perform one or more of the operations described above with respect to the customer data center 100, customer data center 200, auditing system 105, auditing system server(s) 120, auditing module 130, and the flowcharts of FIGS. 3-5 regarding presenting payment recommendations for claims or claim line items to a payor. The claim system interface module 1120 may be configured to perform one or more of the operations described above with respect to the claim systems 102a, 102b, and 102c, customer data center 100, auditing system 105, auditing system server(s) 120, auditing module 130, and the flowcharts of FIGS. 3-5 regarding receiving claims for services performed by providers. The rules module 1125 contains the rules to apply to claims having a date span and may be configured to perform one or more of the operations described above with respect to the auditing system 105, auditing system server(s) 120, auditing module 130, and the flowcharts of FIGS. 3-5 regarding generating a payment recommendation for a claim line item. The communication module 1130 may be configured to perform one or more operations described above with respect to the auditing system 105, auditing system servers 120, auditing module 130, and the flowcharts of FIGS. 3-5 regarding the ability of the auditing system to communicate with other entities including a customer data center.

Although FIGS. 11-12 illustrate hardware/software architectures that may be used in data processing systems, such as the auditing system server(s) 120 and auditing module 130 of FIG. 2, and the data processing system 1000 of FIG. 11, respectively, in accordance with some embodiments of the inventive concept, it will be understood that the present invention is not limited to such a configuration but is intended to encompass any configuration capable of carrying out operations described herein.

Computer program code for carrying out operations of data processing systems discussed above with respect to FIGS. 1-12 may be written in a high-level programming language, such as Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Moreover, the functionality of the auditing system server(s) 120 of FIG. 2, and the data processing system 1000 of FIG. 11 may each be implemented as a single processor system, a multi-processor system, a multi-core processor system, or even a network of standalone computer systems, in accordance with various embodiments of the inventive concept. Each of these processor/computer systems may be referred to as a “processor” or “data processing system.”

The data processing apparatus described herein with respect to FIGS. 1-12 may be used to facilitate generating processing recommendations for health care service claims using an auditing system according to some embodiments of the inventive concept described herein. These apparatus may be embodied as one or more enterprise, application, personal, pervasive and/or embedded computer systems and/or apparatus that are operable to receive, transmit, process and store data using any suitable combination of software, firmware and/or hardware and that may be standalone or interconnected by any public and/or private, real and/or virtual, wired and/or wireless network including all or a portion of the global communication network known as the Internet, and may include various types of tangible, non-transitory computer readable media. In particular, the memory 1105 when coupled to a processor includes computer readable program code that, when executed by the processor, causes the processor to perform operations including one or more of the operations described herein with respect to FIGS. 3-5.

### Further Definitions and Embodiments

In the above-description of various embodiments of the present inventive concept, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present inventive concept. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

In the above-description of various embodiments of the present inventive concept, aspects of the present inventive concept may be illustrated and described herein in any of a number of patentable classes or contexts including any new and useful process, machine, manufacture, or composition of matter, or any new and useful improvement thereof. Accordingly, aspects of the present inventive concept may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present inventive concept may take the form of a computer program product comprising one or more computer readable media having computer readable program code embodied thereon. Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Additionally, the disclosed methods, systems, and computer-program products can optionally be implemented within a cloud computing environment which can facilitate processing of a health claim as software-as-a-service (SaaS). Cloud computing is well-known in the art. Cloud computing enables network access to a shared pool of configurable computing resources (e.g., networks, servers, storage, applications, and services) that can be provisioned and released with minimal interaction. It promotes high availability, on-demand self-services, broad network access, resource pooling and rapid elasticity.

The description of the present inventive concept has been presented for purposes of illustration and description, but is not intended to be exhaustive or limited to the inventive concept in the form disclosed. Many modifications and variations will be apparent to those of ordinary skill in the art without departing from the scope and spirit of the inventive concept. The aspects of the inventive concept herein were chosen and described to best explain the principles of the inventive concept and the practical application, and to enable others of ordinary skill in the art to understand the inventive concept with various modifications as are suited to the particular use contemplated.

What is claimed is:

1. A method, comprising:
receiving a first claim line that identifies a first time span and a first quantity of a health care service provided to a patient during the first time span;
determining whether the quantity of the health care service provided to the patient during the first time span exceeds a maximum amount for a predefined time period;
determining whether the first time span exceeds the predefined time period;
extending the predefined time period past an ending date of the first time span in response to determining that the first time span exceeds the predefined time period and that the quantity of service provided in the first claim line exceeds the maximum amount for the predefined time period; and
generating a payment recommendation for the first claim line in response to determining whether the quantity of the health care service provided to the patient exceeds the maximum amount for the predefined time period and/or in response to determining whether the quantity of the health care service provided in the first time span exceeds a maximum amount for the extended predefined time period.

2. The method of claim 1, further comprising communicating the payment recommendation for the first claim line to a sender of the first claim line.

3. The method of claim 2, wherein the sender is a payor and/or provider of the health care service.

4. The method of claim 1, wherein the predefined time period is one of the following: one or more days, one or more weeks, one or more months, one or more years.

5. The method of claim 1, wherein the payment recommendation is a recommendation to pay or not pay the first claim line.

6. The method of claim 1, wherein the maximum amount for the extended predefined time period is greater than the maximum amount for the predefined time period.

7. The method of claim 1, further comprising:
receiving a second claim line that identifies a second time span and a second quantity of the health care service provided to the patient during the second time span;
determining whether a beginning date of the second time span is within the predefined time period;
extending the predefined time period past an ending date of the second time span; and
generating a payment recommendation for the second claim line in response to determining whether the quantity of the health care service provided to the patient in the first claim line and the quantity of the health care service provided to the patient in the second claim line exceeds a maximum amount for the extended predefined time period, wherein the payment recommendation is a recommendation to pay or not pay the second claim line.

8. The method of claim 7, further comprising communicating the payment recommendation for the second claim line to a sender of the second claim line.

9. The method of claim 7, further comprising:
generating a third claim line in response to determining that the quantity of the health care service provided in the first claim line and the quantity of the health care service provided in the second claim line exceeds the maximum amount for the extended predefined time period, wherein the third claim line contains a quantity of the health care service provided that is less than the quantity of the health care service provided in the second claim line; and
generating a recommendation not to pay the second claim line for a quantity of the health care service in the second claim line that exceeds the maximum amount for the predefined time period and a recommendation to pay the third claim line for a quantity of the health care service in the third claim line that does not exceed the maximum amount for the predefined time period.

10. The method of claim 9, further comprising communicating the payment recommendation for the second claim line and the third claim line to a sender of the first line and the second line.

11. A system, comprising:
a processor; and
a memory coupled to the processor and comprising computer readable program code embodied in the memory that is executable by the processor to perform operations comprising:
receiving a first claim line that identifies a first time span and a first quantity of a health care service provided to a patient during the first time span;
determining whether the quantity of the health care service provided to the patient during the first time span exceeds a maximum amount for a predefined time period;
determining whether the first time span exceeds the predefined time period;
extending the predefined time period past an ending date of the first time span in response to determining that the first time span exceeds the predefined time period and that the quantity of service provided in the first claim line exceeds the maximum amount for the predefined time period;
generating a payment recommendation for the first claim line in response to determining whether the quantity of the health care service provided to the patient exceeds the maximum amount for the predefined time period and/or in response to determining whether the quantity of the health care service provided in the first time span exceeds a maximum amount for the extended predefined time period; and
communicating the payment recommendation for the first claim line to a sender of the first claim line.

12. The system of claim 11, the operations further comprising:
receiving a second claim line that identifies a second time span and a second quantity of the health care service provided to the patient during the second time span;
determining whether a beginning date of the second time span is within the predefined time period;
extending the predefined time period past an ending date of the second time span;
generating a payment recommendation for the second claim line in response to determining whether the quantity of the health care service provided to the patient in the first claim line and the quantity of the health care service provided to the patient in the second claim line exceeds a maximum amount for the extended predefined time period, wherein the payment recommendation is a recommendation to pay or not pay the second claim line; and
communicating the payment recommendation for the second claim line to a sender of the second claim line.

13. The system of claim 12, the operations further comprising:
generating a third claim line in response to determining that the quantity of the health care service provided in the first claim line and the quantity of the health care service provided in the second claim line exceeds the maximum amount for the extended predefined time period, wherein the third claim line contains a quantity of the health care service provided that is less than the quantity of the health care service provided in the second claim line;
generating a recommendation not to pay the second claim line for a quantity of the health care service in the second claim line that exceeds the maximum amount for the predefined time period and a recommendation to pay the third claim line for a quantity of the health care service in the third claim line that does not exceed the maximum amount for the predefined time period; and
communicating the payment recommendation for the second claim line and the third claim line to the sender.

14. The system of claim 12, wherein the sender is a pay or and/or provider of the health care service.

15. The system of claim 12, wherein the predefined time period is one of the following: one or more days, one or more weeks, one or more months, one or more years.

16. A computer program product, comprising:
a non-transitory computer readable storage medium comprising computer readable program code embodied in the medium that is executable by a processor to perform operations comprising:
receiving a first claim line that identifies a first time span and a first quantity of a health care service provided to a patient during the first time span;
determining whether the quantity of the health care service provided to the patient during the first time span exceeds a maximum amount for a predefined time period;
determining whether the first time span exceeds the predefined time period;
extending the predefined time period past an ending date of the first time span in response to determining that the first time span exceeds the predefined time period and that the quantity of service provided in the first claim line exceeds the maximum amount for the predefined time period; and
generating a payment recommendation for the first claim line in response to determining whether the quantity of the health care service provided to the patient exceeds the maximum amount for the predefined time period and/or in response to determining whether the quantity of the health care service provided in the first time span exceeds a maximum amount for the extended predefined time period.

17. The computer program product of claim 16, the operations further comprising:
receiving a second claim line that identifies a second time span and a second quantity of the health care service provided to the patient during the second time span;
determining whether a beginning date of the second time span is within the predefined time period;
extending the predefined time period past an ending date of the second time span;
generating a payment recommendation for the second claim line in response to determining whether the quantity of the health care service provided to the patient in the first claim line and the quantity of the health care service provided to the patient in the second claim line exceeds a maximum amount for the extended predefined time period, wherein the payment recommendation is a recommendation to pay or not pay the second claim line; and
communicating the payment recommendation for the second claim line to a sender of the second claim line.

18. The computer program product of claim 17, the operations further comprising:
generating a third claim line in response to determining that the quantity of the health care service provided in the first claim line and the quantity of the health care service provided in the second claim line exceeds the maximum amount for the extended predefined time period, wherein the third claim line contains a quantity of the health care service provided that is less than the quantity of the health care service provided in the second claim line;
generating a recommendation not to pay the second claim line and a recommendation to pay the third claim line; and
communicating the payment recommendation for the second claim line and the third claim line to the sender.

19. The computer program product of claim 19, wherein the sender is a payor and/or provider of the health care service.

20. The computer program product of claim 16, wherein the predefined time period is one of the following: one or more days, one or more weeks, one or more months, one or more years.
